(19) United States
(12) Patent Application Publication
(10) Pub. No.: US 2026/0230361 A1
(43) Pub. Date: Aug. 6, 2026

(54) RS TRANSMISSION OPPORTUNITIES AND GRANTS IN WIRELESS COMMUNICATIONS

(71) Applicant: ZTE Corporation, Shenzhen (CN)

(72) Inventors: Yu PAN, Shenzhen (CN); Chuangxin JIANG, Shenzhen (CN); He HUANG, Shenzhen (CN); Jing LIU, Shenzhen (CN); Weiqiang DU, Shenzhen (CN); Mengzhen LI, Shenzhen (CN); Qi YANG, Shenzhen (CN)

(73) Assignee: ZTE Corporation, Shenzhen (CN)

(21) Appl. No.: 19/631,326

(22) Filed: Mar. 27, 2026

Related U.S. Application Data
(63) Continuation of application No. PCT/CN2023/122779, filed on Sep. 28, 2023.

(51) Int. Cl. H04L 27/26; H04W 72/25

(52) U.S. Cl. CPC H04L 27/261; H04W 72/25

(57) ABSTRACT

This document generally relates to wireless communication that includes a user device that determines a grant of one or more grants for a reference signal (RS) resource allocation. The user device determines one or more RS characteristics in each RS transmission opportunity of one or more RS transmission opportunities in the grant. Additionally, the user device transmits a RS on each RS transmission duration corresponding to a respective one of the one or more transmission opportunities.

### CROSS-REFERENCE TO RELATED APPLICATION(S)

This application is a continuation of International Patent Application No. PCT/CN2023/122779, filed Sep. 28, 2023. The contents of International Patent Application No. PCT/CN2023/122779 are herein incorporated by reference in their entirety.

### TECHNICAL FIELD

This document is directed generally to reference signal (RS) transmission opportunities and grants for wireless communication.

### BACKGROUND

In wireless communication systems, sidelink (SL)-positioning reference signals (PRS) may be enabled to support sidelink positioning for communication nodes. Regarding sidelink data transmission, a transmitting user device's medium access control (MAC) layer may perform grant determination, logical channel prioritization (LCP), and hybrid automatic repeat request (HARQ) procedures. Ways to improve SL-PRS communication may be desirable.

### SUMMARY

This document relates to methods, systems, apparatuses and devices for wireless communication. In some implementations, a method for wireless communication includes: determining, by a user device, a grant of one or more grants for a reference signal (RS) resource allocation; determining, by the user device, one or more RS characteristics in each RS transmission opportunity of one or more RS transmission opportunities in the grant; and transmitting, by the user device, a RS on each RS transmission duration corresponding to a respective one of the one or more transmission opportunities.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of a wireless access node of the wireless communication system of FIG. 1.

FIG. 3 shows a schematic diagram of a dedicated pool slot structure.

FIG. 4 shows a schematic diagram illustrating SL-PRS resources with and without periodic reservation.

FIG. 5 shows a flow chart of an example method for wireless communication.

FIG. 6 is a timing diagram illustrating an example where the MAC layer chooses more than one SL-PRS in a slot.

FIG. 7 shows a schematic diagram of an example structure of a MAC PDU.

FIG. 8 shows a schematic diagram of an example structure of a SL-SCH sub-header.

FIG. 9 shows a schematic timing diagram of an example of a user device 102 selecting a SL-PRS to transmit.

FIG. 10 shows an example schematic diagram illustrating priority of transmission control.

### DETAILED DESCRIPTION

The present description describes various embodiments of systems, apparatuses, devices, and methods for wireless communications that relates to reference signal (RS) transmission opportunities and grants.

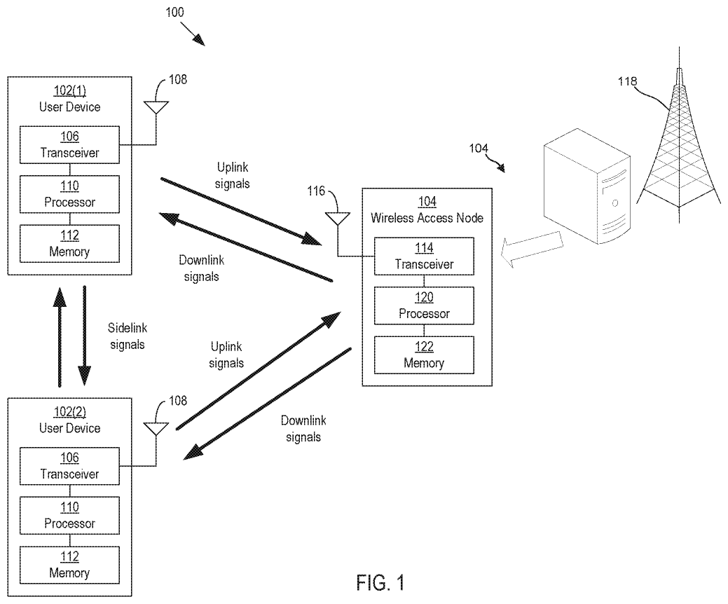

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access node 104. However, various other examples of the wireless communication system 100 that include any of various combinations of one or more user devices 102 and/or one or more wireless access nodes 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include at least one device, electronic and/or network device or apparatus, and may comprise one or more base stations or other wireless network access points capable of communicating wirelessly over a network with one or more user devices and/or with one or more other wireless access nodes 104. For example, the wireless access node 104 may comprise at least one of: a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, or a location management function (LMF), in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

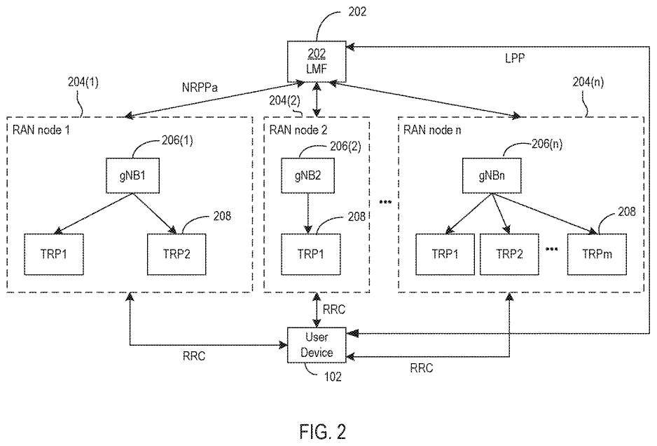

FIG. 2 shows a block diagram of an example configuration of a wireless access node 104. In the example configuration, the wireless access node 104 may include a location management function (LMF) 202 and one or more radio access network (RAN) nodes 204. Some embodiments may include only one RAN node 204. Other embodiments, such as shown in FIG. 2, may include a plurality, or an n-number, of RAN nodes 204(1) to 204(n), where n is two or more. In any of various embodiments, a RAN node 204 may be or include a Next Generation (NG)-RAN node, a gNB, a ng-eNB, a transmission reception point (TRP), and/or a base station, an example of which is shown in FIG. 2. Additionally, each component of the wireless access node 104, such as the LMF 202 and each RAN node 204, may include at least one network device, and/or may be configured in hardware or a combination of hardware and software, such as by having a processor 120, a memory 122, transceiver circuitry 114, an antenna 116, and/or an antenna tower 118, such as shown in FIG. 1 for the wireless access node 104.

Additionally, as shown in FIG. 2, the LMF 202 and each of the RAN nodes 204 may be configured to communicate (transmit and receive) with each other, such as signals or messages, and may be configured to communicate (transmit and receive) with one or more user device 102, either directly or indirectly via another component of the wireless access node 104. For example, the LMF 202 may directly communicate with a user device 102. In particular embodiments, the LMF 202 may directly communicate with a user device 102 according to a Long-Term Evolution (LTE) positioning protocol (LPP) (i.e., via LPP signaling). Also, a RAN node 204 may directly communicate with a user device 102. In particular embodiments, a RAN node 204 may directly communicate with a user device 102 at least via radio resource control (RRC) signaling. In addition, the LMF 202 may directly communicate with each RAN node 204. In particular embodiments, the LMF 202 may directly communicate with each RAN node 204 according to New Radio Positioning Protocol A (NRPPa) (i.e., via NRPPa signaling). Also, for at least some embodiments, such as shown in FIG. 2, each RAN node 204 may include one or more sub-components. For example, a RAN node 204 may include a gNB and/or at least one transmission/reception point (TRP) 208. Additionally, as used herein unless specified otherwise, the terms “network” or “network device” may include at least one gNB 206, at least one ng-eNB, at least one TRP 208, at least one base station, at least one RAN node 204 (e.g., at least one NG-RAN node) and/or at least one LMF 202. Further functionality of the LMF 202 and the RAN nodes 204 is described in further detail below.

In addition, referring back to FIG. 1, in various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels) are used to transmit data signals, and physical control channels (or just control channels) are used to transmit control signals. Example types of physical data channels include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a wireless access node 104 to a user device 102. In other embodiments, the control information includes uplink control information (UCI) that is transmitted in the uplink direction from a user device 102 to a wireless access node 104, or sidelink control information (SCI) that is transmitted in the sidelink direction from one user device 102(1) to another user device 102(2).

Additionally, in some implementations, SL-PRS transmission is enabled to support sidelink positioning. For sidelink data transmission, a transmitting user device's 102 medium access control (MAC) layer may perform grant determination, logical channel prioritization (LCP), and/or hybrid automatic repeat request (HARQ) procedures.

In some implementations, a user device 102 may determine a grant within only one kind of transmission resource pool, even though SL positioning may introduce two pools, such as a shared resource pool and dedicated resource pool. The present description describes ways as to how to determine a grant for SL-PRS transmission for different schemes on a shared resource pool and a dedicated resource pool.

Additionally, in some implementations, when a MAC layer generates a MAC protocol data unit (PDU) to transmit SL data, an LCP procedure may be utilized. However, for SL-PRS, a MAC PDU may not be generated since SL-PRS is a reference signal and it is not combined at the receiving node. The present description describes ways as to how to determine the characteristics of SL-PRS transmission to be transmitted for a grant.

Additionally, in some implementations, retransmission and HARQ feedback for a SL data transmission may be utilized to ensure reliability. Additionally, a time gap restriction between PSSCH, PSCCH and/or physical sidelink feedback channel (PSFCH) may be specified. However, in some implementations for SL-PRS, there is no HARQ feedback mechanism and no PSFCH. The present description describes ways to determine a time gap restriction between two consecutive transmissions.

Additionally, in some implementations, the MAC layer may have up to sixteen SL processes working in parallel to transmit SL data. When the number of SL-PRS transmission requests is relatively large, sidelink positioning quality of service (QoS) requirements may not be satisfied with only one process dedicated for SL-PRS transmission. The present description describes ways to increase the maximum number of SL-PRS processes, especially for dedicated pools.

Additionally, in some implementations, the MAC layer may perform transmit (Tx) resource selection check when the MAC layer determines a selected grant for SL data transmission. The present description describes ways for the user device 102 to determine when to perform Tx resource selection and/or reselection for SL-PRS transmission.

Additionally, in some implementations, the MAC layer may transmit a sidelink shared channel (SL-SCH) together with SL-PRS in a slot. However, sometimes, the SL-SCH may not actually have sidelink data to transmit. The present description describes ways how to indicate to a receiving (Rx) user device 102 whether or not a given SL-SCH has sidelink data to transmit.

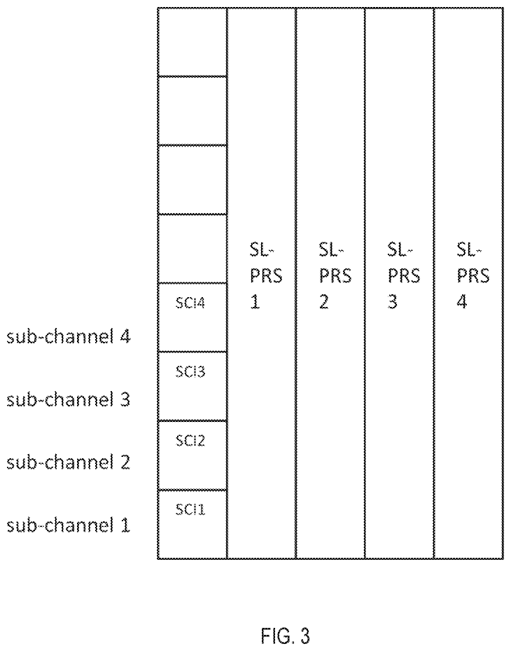

Additionally, for at least some implementations of sidelink positioning, there may be two types of transmission resource pools. A first type of transmission resource pool is called a shared resource pool (otherwise referred to herein as just a shared pool). A second type of transmission resource pool is called a dedicated resource pool (otherwise referred to herein as just a dedicated pool). Also, for at least some implementations, a transmitting user device 102 may be allowed to transmit, in a shared pool, only a PSCCH and a PSSCH, or only a PSCCH and a SL-PRS and a PSSCH in the shared pool. In addition or alternatively, for at least some implementations, a transmitting user device 102 may be allowed to transmit only PSCCH and SL-PRS in a dedicated pool. FIG. 3 shows a schematic diagram of a dedicated pool slot structure.

For at least some implementations, a shared resource pool may not be configured according to Scheme 2 (described in further detail below) for SL data, and may not be configured according to Scheme 1 (described in further detail below) for SL-PRS. Additionally, for at least some implementations, a shared resource pool may not be configured according to Scheme 1 for SL data, and may not be configured according to Scheme 2 for SL-PRS. Also, for at least some implementations, a shared pool and a dedicated pool may be configured for a user device 102 at the same time, and the user device 102 may transmit a SL-PRS on both two types of pools simultaneously. For other reference signals (RSS), a shared pool means the RS and the SL-data may be transmitted in a same pool, and a dedicated pool means the pool of resources may only be used to transmit a RS and corresponding PSCCH and/or feedback signaling.

Additionally, in some implementations of sidelink positioning, SL-PRS transmission may have at least two schemes. For a first scheme, referred to herein as “Scheme 1” or “Scheme 1 for SL-PRS resource allocation”, a transmitting user device 102 may receive SL-PRS resource allocation signaling from the network device 104. In sidelink positioning, a user device 102 configured to perform SL-PRS according to Scheme 1 (referred to herein as a Scheme 1 user device), there may be two ways of performing resource allocation. A first way includes dynamic resource allocation and/or dynamic grant. In the first way, a user device 102 may receive a radio resource control (RRC) configuration of a resource pool, and the user device 102 may receive a DCI format 3-0 scrambled by a sidelink (SL)-radio network temporary identifier (RNTI) to acquire the dynamic granted sidelink resource for transmitting sidelink information and/or SL-PRS. For at least some implementations, the first way may be used for allocating dynamic sidelink resources for emergent services. A second way includes configured grant (CG) resource allocation and/or configured grant. The second way may include two types of CG. In a first type (Type 1 CG), a user device 102 may receive a CG configuration including a resource pool identification (ID), a CG configuration ID, a CG periodicity, and/or a CG resource allocation, and may transmit sidelink information and/or SL-PRS according to an indication in RRC signaling. In a second type (Type 2 CG), a user device 102 may receive a CG configuration including a CG index and a CG periodicity, and may receive a DCI 3-0 scrambled by a SL-configured scheduling (CS)-RNTI to acquire time domain resources and/or information related to the activation and/or deactivation of the CG. In turn, the user device 102 may send and/or stop the sidelink information and/or SL-PRS according to the indication in RRC signaling and/or the DCI.

For a second scheme, referred to herein as “Scheme 2”, a transmitting user device 102 may use a sensing based resource selection to determine the SL-PRS resource allocation. In sidelink positioning, for a user device 102 configured to perform SL-PRS according to Scheme 2 (referred to herein as a Scheme 2 user device 102), a SL grant is referred to as a selected grant, and is selected by the transmitting (Tx) user device 102 itself by sensing or through random selection. For example, when the transmitting user device 102 detects which resources are empty and no other user device 102 occupies them, then the transmitting user device 102 can use and reserve those resources.

For other reference signal (RSs), there may be different schemes from the ones for SL-PRS, such as used to enable the network device 104 to control the resources for sending the RS, or to enable the user deice 102 to perform self-selection on the resources.

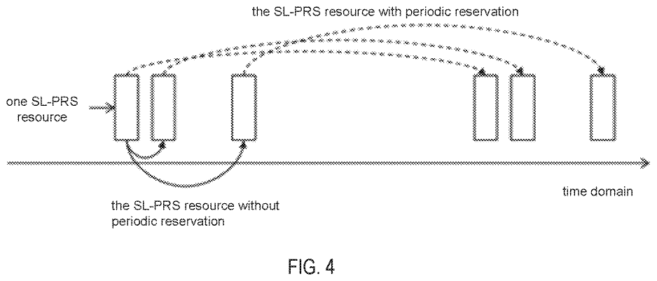

In addition, in some implementations SL-PRS transmissions with and without periodic reservation may be performed in accordance with or using Scheme 1 and/or Scheme 2. For SL-PRS transmissions performed with periodic reservation, SL-PRS transmissions may be reserved with a similar mechanism as the SL periodic resource reservation for another transport block (TB). For SL-PRS transmissions performed without periodic reservation, SL-PRS transmissions are performed in which the SL-PRS is transmitted at least once without periodic reservation, using a similar mechanism as SL resource transmission without periodic reservation. FIG. 4 shows a schematic diagram illustrating SL-PRS resources with and without periodic reservation.

Additionally, a grant is a set of time and frequency resources that can be used to transmit data or reference signal. A grant may include multiple transmission opportunities, such that a single grant corresponds to a single transmission opportunity. Additionally, a single transmission opportunity may correspond to a RS transmission occasion or a RS duration. Further, a transmission opportunity may include at least one of: an initial transmission opportunity and a re-transmission opportunity. Multiple transmission opportunities may be at least one of: non-periodic reserved resource(s) and periodic reserved resource(s). Also, a grant may have one of a plurality of grant types including: a configured grant, a dynamic grant, and a selected grant.

Additionally, a single grant and/or transmission opportunity, may also be called at least one of the following terms: a PSCCH duration, a PSCCH occasion, a RS duration, a RS occasion, a PSSCH occasion, a PSSCH duration, a PSFCH occasion, or PSFCH duration.

In some implementations, a transmission opportunity may depict all allowed resources on which a RS can be transmitted. However, in some situations, the user device 102 may not transmit the RS in every transmission opportunity. In other words, some resources of some of the transmission opportunities may be used, while resources of other transmission opportunities may not be used. Additionally, as used herein, a RS duration and/or an RS occasion means that the RS is determined to be transmitted on a transmission opportunity, and correspondingly, the resources of the transmission opportunities is used.

Additionally, in some implementations involving SL positioning for transmitting a SL-PRS, a transmitting user device 102 may perform one or more of the following actions. The transmitting user device 102 may determine a scheme. In addition or alternatively, the transmitting user device 102 may determines one or more grants and corresponding one or more transmission resource pools. Each grant is a set of time and frequency domain resources to transmit the SL-PRS. Additionally, each grant may have one of the following grant types. In a first grant type, the grant is a configured grant for Scheme 1, has a CG type 1 and/or a CG type 2, and, for at least some implementations, may be associated with a periodicity and/or a retransmission opportunity. In a second grant type, the grant is a dynamic grant for Scheme 1, and for at least some implementations, may be associated with a retransmission opportunity. In a third grant type, the grant is a selected grant for Scheme 2, and for at least some implementations, is associated with a periodicity and/or a retransmission opportunity.

TABLE 1
Dedicated and Shared Pool Characteristics for Scheme 1 and Scheme 2

| | Scheme 1 | Scheme 2 |
|---|---|---|
| Dedicated pool | Network device 104 configures configured | Transmitting user device 102 |
| for SL-PRS | grant/dynamic grant dedicated for transmitting | chooses a selected grant to transmit |
| | PSCCH and SL-PRS, to a Transmitting user | PSCCH and SL-PRS, by itself |
| | device 102 | |
| Shared pool for | Network device 104 configures configured | Transmitting user device 102 |
| SL-PRS and/or | grant/dynamic grant dedicated for transmitting | chooses a selected grant to transmit |
| SL-data | PSCCH, SL-PRS and/or PSSCH, to a | PSCCH, SL-PRS and/or PSSCH, |
| | Transmitting user device 102 | by itself |

Table 1 provides certain characteristics or parameters for dedicated and shared pools in connection with Scheme 1 and Scheme 2.

For each single grant (e.g., a PSCCH duration), a user device 102 may determine which SL-PRS request to prioritize, and the associated SL-PRS to be prioritized is to be transmitted on this single grant. Additionally, a user device 102 may determine the content of sidelink control information (SCI) used for scheduling the SL-PRS, and transmits the SCI and the SL-PRS (with SL-data or without SL-data). Such actions may be performed by the transmitting user device's radio resource control (RRC) layer, medium access control (MAC) layer, and/or physical (PHY) layer, in any of various embodiments. Also, similar or the procedures may be performed for other reference signals, for any other of various embodiments.

Additionally, as used herein, the phrase ‘SL-PRS transmission request’ may be used interchangeably with any or all of the terms: ‘SL-PRS’, ‘SL-PRS transmission’, or ‘SL-PRS transmission pending to transmit’, at least in the context that a ‘SL-PRS transmission request’ may be used to describe the SL-PRS that is pending to be transmitted, and the SL-PRS has associated characteristics, and a SL-PRS request is used for transmitting the corresponding SL-PRS resource on the SL-PRS transmission occasion in the physical layer. Moreover, different SL-PRS transmission requests for SL-PRS transmission may be similar or correspond to different logical channels for sidelink data.

Additionally, the actions performed in the present description may apply to any or all types of reference signals used to transmit on a PC5 interface and using sidelink, such as SL-PRS, sensing RS transmitted in PC5, or other RSs. Accordingly, the present description uses SL-PRS as a non-limiting example of an RS for which the actions described in the present description may be performed. That is to say, reference to SL-PRS is intended to be a non-limiting example of a reference signal (RS), and other kinds of reference signals may be similarly used.

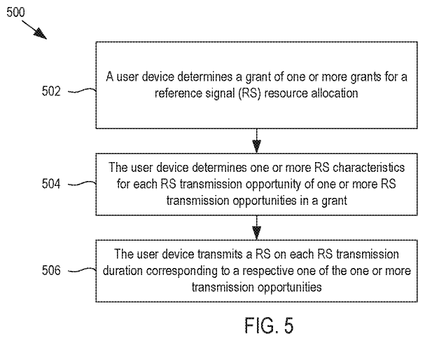

FIG. 5 is a flow chart of an example method 500 for wireless communication that involves reference signal (RS) transmission opportunities. At block 502 a user device 102 determines a grant of one or more grants for a reference signal (RS) resource allocation. At block 504, the user device 102 determines one or more RS characteristics for each RS transmission opportunity of one or more RS transmission opportunities in the grant. At block 506, the user device 102 transmits a RS on each RS transmission duration corresponding to a respective one of the one or more transmission opportunities.

In some implementations of the method 500, the one or more RS characteristics includes at least one of: a session of a RS transmission, a priority of the RS transmission, a cast type of the RS transmission, destination information of the RS transmission, or a sequence identification (ID) of the RS transmission, or a delay budget of the RS transmission.

In some implementations of the method 500, the user device 102 determines a maximum number of parallel processes that the user device 102 can determine for more than one grant to transmit the RS in a dedicated pool. In some of these implementations, the user device 102 determines the maximum number of parallel processes based on a resource selection to determine the RS resource allocation.

In some implementations of the method 500, the user device 102 reports at least one of: a capability of whether the user device 102 supports use of parallel processes for a dedicated pool, or a maximum number of the parallel processes for a dedicated pool that the user device 102 supports.

In some implementations of the method 500, the user device 102 determines more than one RS resource in a slot for a dedicated pool.

In some implementations of the method 500, the one or more RS transmission opportunities comprises an initial RS transmission opportunity and a RS retransmission opportunity, and the user device 102 reselects the grant when a number of unused transmission opportunities in the grant in a dedicated pool reaches a configured parameter, wherein an unused transmission opportunity includes either an initial RS transmission opportunity or a RS retransmission opportunity when a corresponding resource is not used for the RS.

In some implementations of the method 500, the one or more RS transmission opportunities includes an initial RS transmission opportunity and a RS retransmission opportunity, and the user device 102 reselects the grant when a number of unused transmission opportunities in the grant in a shared pool reaches a configured parameter, wherein an unused transmission opportunity includes either an initial RS transmission opportunity or a RS retransmission opportunity when a corresponding resource is not used for the RS and sidelink data.

In some implementations of the method 500, the user device 102 determines the one or more RS characteristics in each RS transmission opportunity to be the same as one or more RS characteristic for a RS transmission having a highest priority among all RS transmissions pending to be transmitted.

In some implementations of the method 500, the user device 102 determines the one or more RS characteristics for a RS in each RS transmission opportunity to be the same as one or more RS characteristics for a RS transmission having a minimum remaining delay budget (DB) among all RS transmissions pending to be transmitted.

In some implementations of the method 500, the one or more RS transmission opportunities includes a RS retransmission opportunity, and wherein the user device 102 determines one or more RS characteristics for a RS in the RS retransmission opportunity to be the same as one or more RS characteristics for a RS in a corresponding initial RS transmission opportunity.

In some implementations of the method 500, the one or more RS characteristics includes a characteristic of whether or not a medium access control (MAC) protocol data unit (PDU) that is transmitted with the RS in a same slot includes only padding bits.

In some implementations of the method 500, the characteristic is indicated in a sidelink shared channel (SL-SCH) subheader of the MAC PDU.

In some implementations of the method 500, the characteristic is indicated in a sidelink control information (SCI) comprising a SCI format 2-D using a source identification (ID) with 0 bits or 24 bits and a destination identification (ID) with 0 bits or 24 bits.

In some implementations of the method 500, the one or more RS characteristics includes a characteristic of whether or not the RS is to be transmitted on a RS transmission opportunity.

In some implementations of the method 500, the user device determines the characteristic according to a first number of consecutive transmissions and a second number of stop transmissions. In some of these implementations, at least one of: when a first RS with a priority is transmitted consecutively to a destination for the first number, transmission of a second RS with the priority to the destination is suspended for the second number; when a first RS with a priority is transmitted consecutively in a session for the first number, transmission of a second RS with the priority in the session is suspended for the second number; the consecutive transmissions for the first number and the stop transmissions for the second number each include at least one of the following: initial transmissions, initial transmissions and retransmissions, initial transmissions to the destination, initial transmissions and retransmissions to the destination, initial transmissions of the session, or initial transmissions and retransmissions of the session. In some of these implementations, the initial transmission occurs on the initial transmission opportunity, and the retransmission occurs on the retransmission opportunity.

In some implementations of the method 500, the user device 102 determines the one or more RS characteristics according to a first time period of consecutive transmissions and a second time period of stop transmissions. In some of these implementations, at least one of: when a first RS with a priority is transmitted consecutively to a destination for the first time period, transmission of a second RS with the priority to the destination is suspended for the second time period; or when a first RS with a priority is transmitted consecutively in a session for the first time period, transmission of a second RS with the priority in the session is suspended for the second time period.

In some implementations of the method 500, the user device 102 determines the characteristic according to a user device variable among one or more user device variables, wherein each user device variable of the one or more user device variables is associated to a second RS characteristic. In some of these implementations, the second RS characteristic includes at least one of the destination of the RS transmission, or the session of the RS transmission. In addition or alternatively, at least one of: an initial value of the user device variable is set to a priority value of a current RS transmission; the user device variable value is increased by one when a RS with the second characteristic is successfully transmitted on the RS transmission opportunity; the user device variable value is decreased by one when a RS with the second characteristic pending to transmit and is not transmitted on the RS transmission opportunity; the user device variable is decreased by one when a the RS with the second characteristic pending to transmit and is not transmitted during a predetermined time period. In addition or alternatively, the user device 102 determines the one or more RS characteristics for a RS in each RS transmission opportunity to be the same as one or more RS characteristic for a RS transmission having a lowest user device variable value among all of the RS transmissions pending to be transmitted.

In some implementations of the method 500, the one or more RS characteristics includes a time gap between two consecutive transmissions, wherein the two consecutive transmissions includes at least one of: two RSs, a physical sidelink control channel (PSCCH) and the RS, or a physical sidelink shared channel (PSSCH) and the RS. For at least some of these implementations, at least one of: the time gap or a maximum time gap between the two consecutive transmissions is configured by a communication node other than the user device, wherein the communication node includes a gNB 206 that configures the time gap via radio resource control (RRC) signaling, a location management function (LMF) 202 that configures the time period via sidelink positioning protocol (SLPP) signaling or LTE positioning protocol (LPP) signaling, or a second user device 102 that configures the time period via SLPP signaling or PC5-RRC signaling; or the user device reports a minimum time gap between the two consecutive transmissions that the user device is capable of using.

Further details of various actions performed by communication nodes in the wireless communication system 100 are now described, any or all of which may be incorporated into any of various implementations of the method 500 or other methods.

In some implementations, at a slot n, a MAC layer of a communication node (e.g., a user device 102 or a network device 104) may trigger a physical (PHY) layer to perform resource selection for dedicated pool used for transmitting a SL-PRS. Since the slot pattern for the dedicated pool is already configured by the network device (e.g., gNB 206) or pre-configured, the PHY layer may choose one or more SL-PRS resources in a slot and generate a set of resources that the PHY layer chooses. Additionally, in some implementations, the MAC layer may choose a resource randomly from the SA. Accordingly, to select a grant, the MAC layer may choose to have more than one SL-PRS resource in a slot, and/or to have only one SL-PRS resource in a slot. Such features may be beneficial for, but not limited to, a multiple beam scenario.

Additionally, in some implementations, a transmitting user device 102 may receive a configured grant or a dynamic grant from a network device 104 (e.g., a gNB 206), indicating that there are more than one SL-PRS resource that can be used in a dedicated pool.

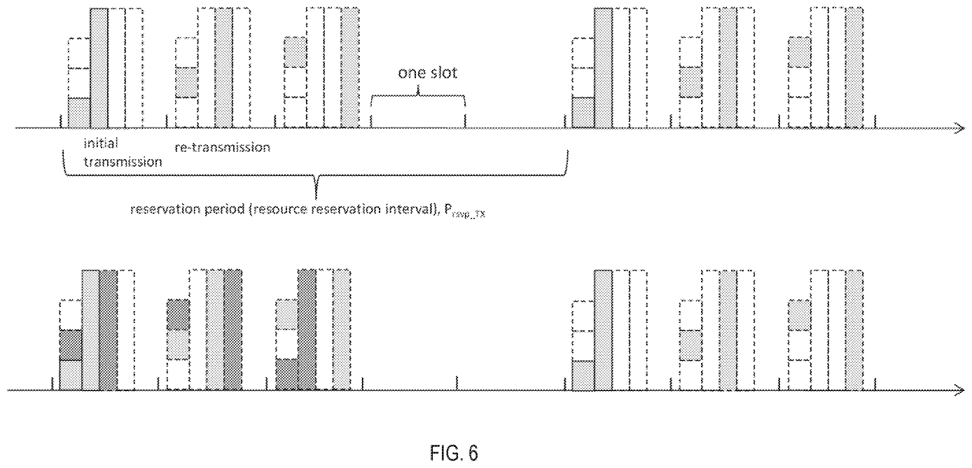

Additionally, in some implementations, the more than one SL-PRS resource may be associated with a single PSCCH within one slot, or not associated with any PSCCH within one slot, or each SL-PRS resource is associated with a corresponding PSCCH within one slot. Also, PSCCHs within one slot may be frequency division multiplexed (FDM'ed) or time division multiplexed (TDM'ed), and/or the SL-PRS resources within one slot may be FDM'ed or TDM'ed. In addition or alternatively, the SL-PRSs and PSCCHs within one slot can be TDM'ed. FIG. 6 is a timing diagram illustrating an example where the MAC layer chooses more than one SL-PRS in a slot.

Additionally, in some implementations, a transmitting user device 102 may transmit a SL-PRS in a slot, or a SL-PRS and a PSSCH together in a slot, within a shared transmission resource pool.

In some implementations, when a transmitting user device 102 transmits a SL-PRS and a PSSCH in a slot in a shared transmission resource pool, the transmitting user device 102 may send a first stage sidelink control information (SCI) format 1-A. The SCI format 1-A indicates a SCI format 2-D. In turn, the transmitting user device 102 may send a second stage SCI format 2-D. The SCI format 2-D indicates a SL-PRS resource ID, and indicates one or more fields that are the same with the fields in SCI format 2-A or SCI format 2-B.

Additionally, in some implementations, when a transmitting user device 102 transmits only PSSCH in a slot in a shared transmission resource pool, the transmitting user device 102 may send a SCI format 1-A, where the SCI format 1-A indicates the second SCI format 2-A, 2-B or 2-C.

Additionally, for at least some implementations, the fields in SCI format 1-A are:
Priority—3 bits,
Frequency resource assignment,
Time resource assignment—5 or 9 bits,
Resource reservation period—┌log₂ N_{rsv_period}┘ bits,
DMRS pattern—┌log₂ Nₚₐₜₜₑᵣₙ┘ bits,
2^{nd}-stage SCI format—2 bits,
Beta_offset indicator—2 bits,
Number of DMRS port—1 bit,
Modulation and coding scheme—5 bits,
Additional MCS table indicator—0, 1, or 2 bits,
PSFCH overhead indication—1 bit,
Conflict information receiver flag—0 or 1 bit.

Additionally, for at least some implementations, the fields in SCI format 2-A and 2-B are:
HARQ process number—4 bits,
New data indicator—1 bitRedundancy version—2 bits,
Source ID—8 bits,
Destination ID—16 bits,
HARQ feedback enabled/disabled indicator—1 bit,

Cast type indicator—2 bits,
CSI request—1 bit,
Zone ID—12 bits,
Communication range requirement—4 bits.

Additionally, in some implementations when a transmitting user device 102 transmits a SL-PRS and a PSSCH in a slot in a shared transmission resource pool, there is a possibility that the PSSCH contains SCI and SL-SCH, but the SL-SCH has no actual sidelink data to be transmitted. That means the medium access control (MAC) protocol data unit (PDU) (excluding the SL-SCH subheader) may include only padding bits. The sidelink data or actual data here refers to the MAC service data unit (SDU) with SL data, and/or a MAC CE.

Additionally, in some implementations, a transmitting user device 102 may know whether a MAC PDU, a TB or a PSSCH (that is transmitted with the SL-PRS in a same slot) has actual data to transmit or not. However, the receiving user device 102 may not know this. In this case, to indicate to the receiving user device 102 that the PSSCH includes actual sidelink data or the PSSCH only includes padding bits, the following actions may be performed.

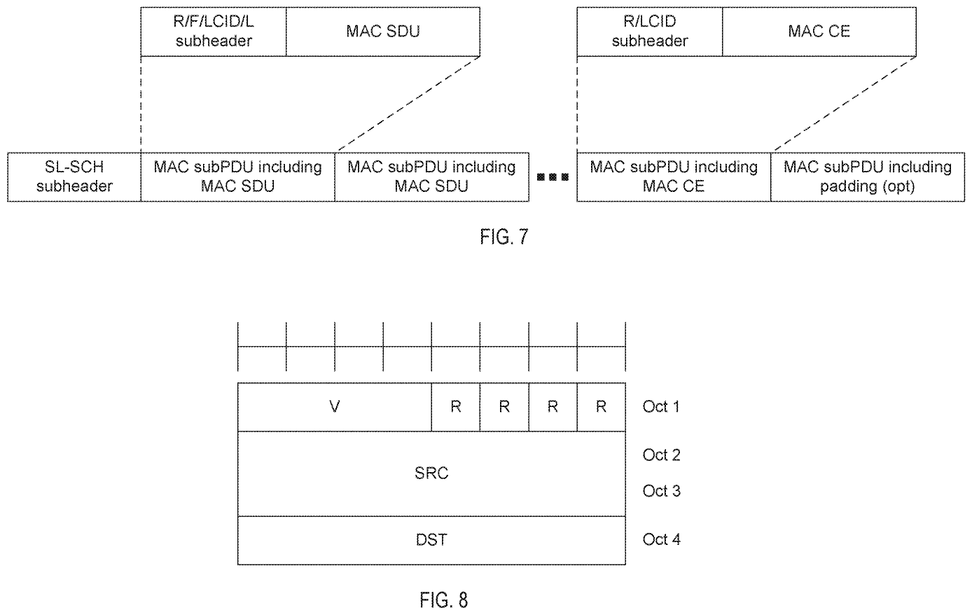

FIG. 7 shows a schematic diagram of an example structure of a MAC PDU. FIG. 8 shows a schematic diagram of an example structure of a SL-SCH sub-header. For at least some implementations, each MAC PDU may have a SL-SCH subheader to indicate the MAC PDU's source ID and destination ID information. Additionally, each MAC PDU may include one or more MAC SDUs or MAC CEs. Each MAC SDU or MAC CE has a MAC subheader to indicate the MAC SDU's or MAC CE's LCID and length. The transmitting user device 102 may use one of reserved (R) bits in the SL-SCH subheader of the MAC PDU to indicate that the MAC PDU includes data, or all of the MAC SDUs or MAC CEs in the MAC PDU include only padding bits.

In this way, when the receiving user device 102 receives SCI 2-D and the following MAC PDU, the receiving user device's 102 MAC layer may decodes the SL-SCH subheader and locate the field that indicates that the MAC PDU includes data. Additionally, the receiving user device 102 may continue to decode the MAC PDU and deliver the decoded MAC PDU to a disassembly and demultiplexing entity of the receiving user device 102. If the receiving user device's MAC layer decodes the SL-SCH subheader and locates the field that indicates the MAC PDU does not include data, the receiving user device's 102 MAC layer may directly ignore or drop the MAC PDU.

Additionally, in some implementations, the SCI format 2-D may include two fields. A first field may indicate a source ID for SL-PRS. A second field may indicate a destination ID for SL-PRS. The source ID and the destination ID may be 0 bits or 24 bits, depending on different conditions. To save SCI overhead, the user device 102 may not carry the total of 48 bits each time in SCI 2-D transmission.

In event that the transmitting user device 102 confirms that a PSSCH that is transmitted with the SL-PRS in a slot has actual data to transmit, the transmitting user device 102 may set the field of source ID for the SL-PRS as 0 bits, and sets the field of destination ID for SL-PRS as 0 bits. Additionally, when the receiving user device 102 receives the SCI 2-D with 0 bits of both fields, the receiving user device 102 may know or determine that the PSSCH actually includes data to be transmitted that the receiving user device 102 is to receive and process. In some implementations, the SL-PRS and the PSSCH in a slot belong to a same destination ID and a source ID. In such embodiments, the receiving user device 102 may receive and decode the PSSCH with the SCI 2-D information and SL-SCH subheader, and receive and process the SL-PRS.

Additionally, in event that the transmitting user device 102 confirms that a PSSCH that is transmitted with the SL-PRS in a slot does not have actual data to transmit, the transmitting user device 102 may set the SCI 2-D to contain the 24 bit source ID for SL-PRS and the 24 bit destination ID for the SL-PRS. When the receiving user device 102 receives the SCI 2-D with 24 bits in both fields, the receiving user device 102 may know the PSSCH includes only padding bits. In turn, the receiving user device 102 may drop the PSSCH reception and decoding procedure. Additionally, the receiving user device 102 may use the 24 bit source and destination IDs in the SCI2-D to confirm whether the SL-PRS in this slot is to be received by the receiving user device 102.

The following describes ways a user device 102 may determine one or more characteristics of a SL-PRS transmission on each transmission opportunity. Such ways may apply to both a shared pool and a dedicated pool, and/or may apply to both Scheme 1 and to Scheme 2.

In further detail, in some implementations, a user device 102 may determine one or more grants to transmit a SL-PRS. One grant may include non-periodic reserved resources and/or periodic reserved resources. Each non-periodic reservation resource and/or periodic reservation resource may map to and/or be associated with a PSCCH duration or SL-PRS transmission occasion/SL-PRS transmission opportunity. Also, each non-periodic reserved resource and/or periodic reserved resource in a grant may also be called or referred to as a single grant of this grant. Also, each first transmission opportunity for each periodic reservation is called initial transmission opportunity, and the other single grants in this grant can be called retransmission opportunity.

Additionally, in some implementations, a grant is at least one of a configured grant, a dynamic grant, or a selected grant. When a transmitting user device 102 has received a SL-PRS transmission request from an upper layer (e.g., a layer higher than the MAC layer) or from another user device 102, or the transmitting user device 102 generates the SL-PRS transmission request at its own MAC layer, since there may be multiple SL-PRS transmission requests coming at one time that are pending for transmission, the transmitting user device 102 may determine which SL-PRS transmission request(s) are to be satisfied, and the corresponding SL-PRS are to be transmitted on each single grant. In other words, a transmitting user device 102's MAC layer may be triggered with one or multiple SL-PRS transmissions that are pending to be transmitted.

Additionally, each SL-PRS transmission request may be associated with at least one of the following: a SL-PRS transmission request ID, which is an identifier of the SL-PRS transmission pending to be transmitted; different sessions, such as for example a SL positioning session, or another session of other services (a session may have a SL positioning session ID, a LPP session ID, or other session ID); a priority value associated with a SL-PRS, with the SL positioning session, or with the SL-PRS transmission request; a cast type (e.g., broadcast, groupcast, unicast); a delay budget (DB), such as a remaining DB associated with a SL-PRS, with a SL positioning session, or with the SL-PRS transmission request; destination information associated with a SL-PRS, with a SL positioning session, with a SL-PRS transmission request, or with a destination ID; a number of retransmission times; a periodicity of a SL-PRS transmission; or a sequence ID for sending corresponding SL-PRS.

In addition, each SL-PRS transmission may have one or more of any of the above characteristics that can be associated with a SL-PRS transmission request. Other or additional characteristics for a SL-PRS may include at least one of: whether or not the SL-PRS transmission is be transmitted on a transmission opportunity; whether or not the MAC PDU that is transmitted with a SL-PRS in a same slot includes only padding bits; or a time gap between two consecutive transmissions.

Additionally, in some implementations, each single grant may correspond to a SL-PRS resource and a corresponding PSCCH in a slot, or each single grant may correspond to a SL-PRS resource in a slot. One slot may have one or more single grants. In a first case, in event that one user device 102 is only allowed to transmit one PSCCH and a corresponding SL-PRS resource in a slot, each single grant may include one PSCCH and a corresponding SL-PRS resource in a slot. In turn, the user device 102 may only transmit a single SL-PRS corresponding to a single SL-PRS transmission request in a slot. The SL-PRS and corresponding PSCCH is TDMed within the slot. In a second case, in event that a user device 102 is allowed to transmit more than one SL-PRS resource in a slot, one slot may have multiple single grants. In turn, the user device 102 may transmit multiple SL-PRSs corresponding to multiple SL-PRS transmission requests in a slot.

For the above two cases, if there are multiple SL-PRS transmission requests coming (i.e., the corresponding SL-PRSs are pending to be transmitted) at each single grant, the transmitting user device 102 may determine or choose which SL-PRS transmission request is to be satisfied and the corresponding SL-PRS is to be transmitted on each single grant according to at least one of the following configurations (i.e., the transmitting user device 102 determines the characteristics of SL-PRS transmission on a single grant according to at least one of the following configurations).

In a first configuration, a user device 102 may choose the SL-PRS transmission request with a highest priority. That is, the transmitting user device 102 may determine SL-PRS transmission characteristics on each transmission opportunity to be the same as the characteristics of the SL-PRS transmission with the highest priority at that time. The transmission opportunity can be at least one of an initial transmission opportunity or a retransmission opportunity. The SL-PRS transmission with the highest priority at that time may include that the SL-PRS transmission with the highest priority within all the SL-PRS transmissions pending to be transmitted and joins the prioritization or LCP at the time, or the SL-PRS transmission with the highest priority within all of the SL-PRS transmissions pending to transmitted at the time. As used herein, a transmission that joins the prioritization or LCP means that the transmission can be, or is allowed to be, chosen for transmission in a transmission opportunity, or can be, or is allowed to be, multiplexed in a MAC PDU for transmission in a transmission opportunity. For at least some implementations, the transmission can be, or is allowed to be, chosen or multiplexed in a MAC PDU for transmission in a transmission opportunity in the context that the communication nodes in the wireless communication system 100 may operate in accordance with certain specifications or rules that prohibit one or more of the transmissions to be transmitted in one or more of the transmission opportunities.

In a second configuration, the user device 102 may choose the SL-PRS transmission request with a minimum remaining DB. That is to say, the transmitting user device 102 determines SL-PRS transmission characteristics on each transmission opportunity to be same as the characteristic of the SL-PRS transmission that with the minimum remaining DB at that time. The transmission opportunity may be at least one of an initial transmission opportunity or a retransmission opportunity. The SL-PRS transmission with the minimum remaining DB at that time may include that the SL-PRS transmission with the minimum remaining DB within all of the SL-PRS transmissions pending to be transmitted and joins the prioritization or LCP at the time, or the SL-PRS transmission with the minimum remaining DB within all of the SL-PRS transmissions pending to be transmitted at the time.

In a third configuration, if the same SL-PRS transmission request in a corresponding initial transmission opportunity time is still available, then the user device 102 may select the SL-PRS transmission request in the retransmission opportunity as the same SL-PRS transmission request in the corresponding initial transmission opportunity time, where an SL-PRS transmission request in an initial transmission opportunity is the same as a SL-PRS transmission request in a retransmission opportunity where at least one of their respective characteristics are the same. On the other hand, if at this time the SL-PRS transmission request corresponding to the initial transmission opportunity is not available, then the user device 101 may select any SL-PRS transmission request. For initial transmission opportunities, the user device 102 may select any SL-PRS transmission request. That is to say, the transmitting user device 102 may determine the SL-PRS transmission characteristics in the retransmission opportunity to be the same as the SL-PRS transmission characteristics in the corresponding initial transmission opportunity. Correspondingly, the user device 102 may determine the characteristic(s) of the new transmission in the new transmission opportunity according to the characteristic(s) of all of the SL-PRS transmissions pending to be transmitted with the highest priority or the minimum remaining DB.

In other implementations or situations where the user device 102 is allowed to transmit more than one SL-PRS resources in a slot, the user device 102 may determine or select which SL-PRS transmission request is to be satisfied and the corresponding SL-PRSs are to be transmitted on each slot according to at least one of the following procedures (i.e., the user device 102 may determine the characteristic(s) of more than one SL-PRS transmission in a slot according to at least one of the following procedures).

In a first procedure, the user device 102 may determines a destination and a cast type of a SL-PRS transmission request with the highest priority, and select the SL-PRS transmission request. In a second procedure, the user device 102 may determine the SL-PRS transmission request(s) that has/have the same destination and cast type as the selected SL-PRS transmission request, according to the remaining DB and the number of single grants in a slot. In a third procedure, the user device 102 may transmit one or more SL-PRSs in a slot according to the selected SL-PRS transmission request.

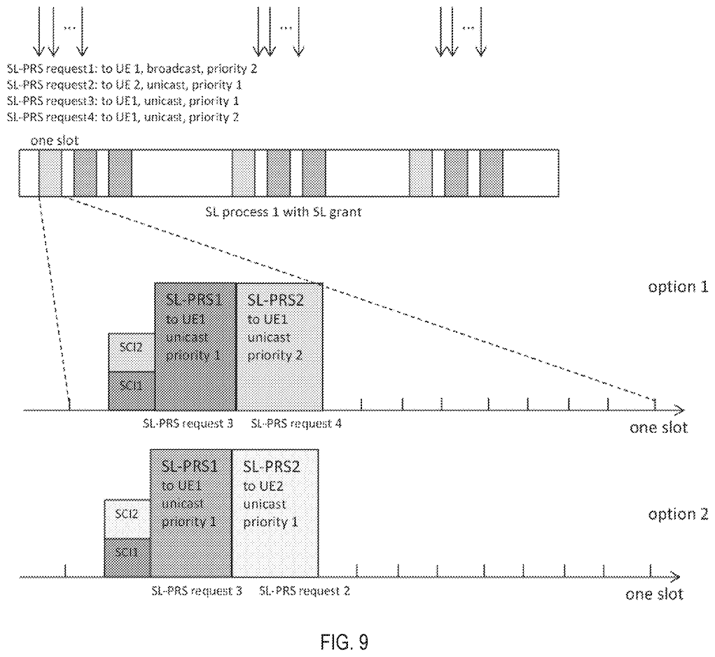

FIG. 9 shows a schematic timing diagram of an example of a user device 102 selecting a SL-PRS to transmit. Additionally, an UL MAC CE for requesting a DG resource may include a preference of a pool (e.g., a shared pool or dedicated pool). Additionally, an UL RRC message for requesting CG resource may include a preference of a pool (e.g., a shared pool or dedicated pool).

In some implementations, including those applicable to a dedicated pool and/or a shared pool, and/or those applicable to Scheme 1 and/or Scheme 2, a grant may include at least one of a configured grant, a dynamic grant, and/or a selected grant. The grant may be a grant with non-periodicity reserved resources, or may be a grant with non-periodicity reserved resources and periodicity reserved resources.

In event that the user device 102 has already determined a grant to transmit a SL-PRS, and in event that the user device 102 selects to transmit a SL-PRS with the highest priority in each single grant, then there is a possibility that the SL-PRS request with the highest priority will keep on transmitting. In such a situation, then the SL-PRS with a lower priority may not have a chance to transmit, and the SL positioning may fail frequently. To prevent against failure, a priority rule for transmitting SL-PRS is implemented. For at least some implementations, the priority rule may be applied to both new transmission opportunities and re-transmission opportunities. In addition or alternatively, the priority rule may only be applied to whenever a new transmission is performed.

For at least one of a broadcast, a groupcast, and or unicast of a SL-PRS transmission request or a SL-PRS, a transmitting user device 102 may use the grant to transmit the SL-PRS to multiple destinations. If for a destination, there are more than one SL positioning sessions and each SL-PRS transmission request is associated with a priority, then to ensure a lower priority SL-PRS also has a chance to be transmitted to the destination, at least one of the following configurations may be implemented (Or otherwise stated, a user device 102 may have multiple SL positioning sessions simultaneously, and for each SL positioning session, there may be multiple SL-PRS transmission requests associated with a SL positioning session. If, for a sidelink positioning session each SL-PRS transmission request is associated with a priority, then to ensure a lower priority SL-PRS also has chance to transmit for the SL positioning session, then at least one of the following configurations may be implemented).

In a first configuration, each SL-PRS priority may be associated with a first number of consecutive transmissions, X. In addition, each SL-PRS priority may be associated with a second number of stop transmissions, Y. The user device 102 can count according to the following: if SL-PRS transmission requests with the priority of a certain destination ID has been satisfied and a corresponding SL-PRS with the certain priority is transmitted to the certain destination ID consecutively for X times or X single grants, this priority should be suspended for Y times or Y single grants. That is to say, to a certain destination ID, the user device 102 may not select SL-PRS request with this priority and does not transmit SL-PRS with this priority for Y times. Other implementations may employ the same first configuration, but use or are applicable for a certain sidelink positioning session ID, instead of a certain destination ID. Also, the suspension or stopping Y times may include that the SL-PRS transmissions with a certain priority that are pending to be transmitted to a certain destination or a session will not join the prioritization for the Y times, even if these SL-PRS transmissions still wait to be transmitted in the next several transmission opportunities.

In a second configuration, the X consecutive transmissions that are counted only include initial transmissions, or include both initial transmissions and re-transmissions. Also, the Y number of stop transmissions that are counted include initial transmissions that are not transmitted, or include both initial transmissions and re-transmissions that are not transmitted. For some implementations of the second configuration, the X consecutive transmissions that are counted include only initial transmissions for a certain destination or a certain SL positioning session, or include only initial transmissions and re-transmissions for a certain destination or a certain SL positioning session. Similarly, the Y number of stop transmissions that are counted as not transmitting include initial transmissions for a certain destination or a certain SL positioning session for Y times, or include both initial and re-transmissions for a certain destination or a certain SL positioning session for Y times.

In a third configuration, each SL-PRS priority may be associated with a first time period A, and each SL-PRS priority may be associated with a second time period B. The user device 102 may count according to the following: in event that SL-PRS transmission requests with the priority of a certain destination ID have been satisfied and the corresponding SL-PRS with the certain priority is transmitted to the certain destination ID consecutively, and the transmission time reaches the first time period A (starting from the first SL-PRS transmission to this destination ID with this priority), then the user device 102 may stop transmitting the SL-PRS with this priority to this destination ID for the second time period B. In other implementations, similar actions may be performed according the third configuration, but for a certain sidelink positioning ID instead of a certain destination ID. Additionally, suspending or stopping for a time period B includes the SL-PRS transmissions pending to be transmitted are not part of the prioritization for the time period B.

In a fourth configuration, each SL-PRS priority may be associated with a first number of consecutive transmissions X. In addition, each SL-PRS priority may be associated with a second time period B. In event that SL-PRS transmission requests with the priority of a certain destination ID has been satisfied and the corresponding SL-PRS with the certain priority is transmitted to the certain destination ID consecutively for X times or X single grants, the user device 102 may stop transmitting the SL-PRS with this priority to this destination ID for the second time period B. For other implementations, similar actions may be performed according to the fourth configuration, but for a certain sidelink positioning session ID instead of a certain destination ID.

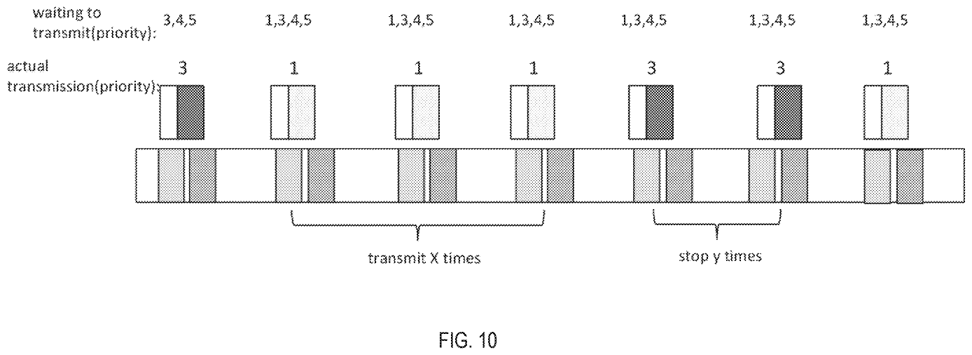

Additionally, in any of various implementations, the above-described associations between a priority and count X, count Y, time period A, and/or time period B may be configured by radio resource control (RRC) signaling from a network device 104 (e.g., gNB 206) to the transmitting user device 102. In addition or alternatively, the associations may be configured per resource pool or per user device 102. In addition or alternatively, the above associations between priority and count X, count Y, time period A, and/or time B may also be configured by SLPP signaling from the LMF 202 to the transmitting user device 102, or from another user device 102 (e.g., a server user device 102) to the transmitting user device 102. In addition or alternatively, the associations between priority and count X, count Y, time period A, and/or time period B may be pre-configured or fixed in the specification. In addition or alternatively, the associations between priority and count X, count Y, time period A, and/or time period B may included in a UE capability report to the LMF 202, a gNB 206 or another user device 102. In addition or alternatively, count X and/or count Y may each be integers larger than 0. In addition or alternatively, units of each of time period A and/or time period B may be at least one of a symbol, a slot, a sub-slot, a subframe, a radio frame, a millisecond, or a second. FIG. 10 shows an example schematic diagram illustrating priority of transmission control.

Additionally, in some implementations, for shared a pool, when a user device 102 has data from a sidelink control channel SCCH, data from a sidelink traffic channel (STCH), or a sidelink MAC CE that is pending to be transmitted, their priority has a restricted order as follows:

Logical channels are prioritized in accordance with the following order (highest priority listed first):
data from SCCH;
Sidelink CSI Reporting MAC CE;
Sidelink Inter-UE Coordination Request MAC CE and Sidelink Inter-UE Coordination Information MAC CE;
Sidelink DRX Command MAC CE;
data from any STCH.
Additionally, in some implementations, when a SL-PRS joins the prioritization, the SL-PRS may not be prioritized higher than the data from a STCH and the SL MAC CE. Correspondingly, when in a shared pool, the user device's 102 MAC layer/entity may choose the destination of the transmission to be the same as the destination of the pending transmission that has the highest priority, or the user device's 102 MAC layer/entity may determine whether the SL-PRS is to be transmitted or not on a transmission opportunity based on the priority order. The priority order from highest to the lowest should be: data from SCCH, SL MAC CE, data from STCH, and SL-PRS (depending on the configured priority). In this way, the priority of data from the STCH and the priority of the SL-PRS are compared together. In event that the configured priority for data from the STCH and the SL-PRS have the same configured priority value, the destination may be determined based on implementation specifics.

In other implementations, the priority order from highest to the lowest may be: data from SCCH, SL MAC CE, data from STCH, SL-PRS.

Additionally, in some implementations, logical channels including data from a SCCH and a sidelink MAC CE generated by the MAC layer may have a fixed priority value. Also, the data from the STCH and the SL-PRS may have respective priority values that are each configurable.

Additionally, some implementations may utilize a user device variable (also called a UE variable) Z to control the selection of SL-PRS. For at least some of these implementations, each SL-PRS transmission request may maintain or include a UE variable Z. Different SL-PRS transmission request may maintain or include a correspondingly UE variable Z independently and/or in parallel. UE variable Z may have the same value range, e.g., eight levels, with a SL-PRS priority value, e.g, 0-7 or 1-8. In particular of these implementations, such as used herein unless expressly described otherwise, the lowest priority value indicates the highest priority, and vise versa. For a priority value range 0-7, if Z is decreased to 0, Z cannot be decreased anymore. Similarly; if Z is increased to 7, Z cannot be increased anymore. Likewise, for a priority value range 1-8, Z cannot be decreased to lower than 1, and Z cannot be increased to higher than 8. Also, for at least some implementations, a user device 102 may set an initial Z value as the priority value of a current SL-PRS transmission request. In particular of these implementations, the user device 102 may select, such as always select, the SL-PRS transmission request with the lowest Z value in each single grant. If different SL-PRS transmission requests have the same Z value at one time, the user device 102 may select the SL-PRS transmission request, which may depend on implementation specifics in any of various implementations.

Also, in some implementations, at least one of the following ways can be used to determine whether two or more SL-PRS transmission requests can be determined to be the same SL-PRS transmission request with a same UE variable Z. In a first way, if the two or more SL-PRS transmission requests arrive at different time, then the two or more SL-PRS transmission requests are not determined to be the same SL-PRS transmission request. In turn, the user device 102 determines to apply independent or separate UE variable Zs to the two or more SL-PRS transmission requests. In a second way, If the two or more SL-PRS transmission requests arrive at different times but have the same associated destination information, the user device 102 may determine the two or more SL-PRS transmission requests to be the same SL-PRS transmission request. In turn, the user device 102 may determine to apply the same UE variable Z to the two or more SL-PRS transmission requests. In a third way, if the two or more SL-PRS transmission requests arrive at different time and have the same associated sidelink positioning session information, the user device 102 may determine the two or more SL-PRS transmission requests to be the same SL-PRS transmission request. In turn, the user device 102 may apply the same UE variable Z to the two or more SL-PRS transmission requests. In a fourth way, if the two or more SL-PRS transmission requests arrive at different times and have the same associated SL-PRS transmission request ID, the user device 102 may determine the two or more SL-PRS transmission requests to be the same SL-PRS transmission request. In turn, the user device 102 may apply the same UE variable Z to the two or more SL-PRS transmission requests. In a fifth way, if the two or more SL-PRS transmission requests arrive at different times but have the same associated cast type, the user device 102 may determine the two or more SL-PRS transmission requests to be the same SL-PRS transmission request. In turn, the user device 102 may apply the same UE variable Z to the two or more SL-PRS transmission requests. In a sixth way, if the two or more SL-PRS transmission requests arrive at different times but have the same associated number of retransmission times, the user device 102 may determine the two or more SL-PRS transmission requests to be the same SL-PRS transmission request. In turn, the user device 102 may apply the same UE variable Z to the two or more SL-PRS transmission requests. In a seventh way, if the two or more SL-PRS transmission requests arrive at different times and have the same associated periodicity of SL-PRS transmission, the user device 102 may determine the two or more SL-PRS transmission requests to be the same SL-PRS transmission request. In turn, the user device 102 may apply the same UE variable Z to the two or more SL-PRS transmission requests. In an eighth way, if the two or more SL-PRS transmission requests arrive at different times but have the same associated sequence ID for sending corresponding SL-PRS, the user device 102 may determine the two or more SL-PRS transmission requests to be the same SL-PRS transmission request. In turn, the user device 102 may apply the same UE variable Z to the two or more SL-PRS transmission requests. In a ninth way, if the two or more SL-PRS transmission requests arrive at different times but have the same associated delay budget (DB) or remaining DB, the user device 102 may determine the two or more SL-PRS transmission requests to be the same SL-PRS transmission request. In turn, the user device 102 may apply the same UE variable Z to the two or more SL-PRS transmission requests. In a tenth way, if the two or more SL-PRS transmission requests arrive at different times but have the same associated priority, then the user device 102 may determine the two or more SL-PRS transmission requests to be the same SL-PRS transmission request. In turn, the user device 102 may apply the same UE variable Z to the two or more SL-PRS transmission requests.

Additionally, in some implementations, for each SL-PRS transmission request with the same UE variable Z, the user device 102 may perform one or more of the following procedures. In a first procedure, in event that a SL-PRS transmission request has been selected and a corresponding SL-PRS is transmitted for a single grant, the corresponding UE variable Z is increased by 1. Correspondingly, the next time a SL-PRS transmission request with the same UE variable Z arrives, the UE variable Z is incremented by 1, i.e., Znew=Zold+1. In a second procedure, if a SL-PRS transmission request is waiting to be transmitted, but is not transmit for a certain time, then the corresponding UE variable Z is decreased by 1. Correspondingly, the next time a SL-PRS transmission request with the same UE variable Z waits for a certain time, the UE variable Z is decremented by 1, i.e., Znew=Zold−1. Additionally, in some implementations, the certain time may be a certain time period with the unit of at least one of symbol, slot, ms, subframe, radio frame or second. In addition or alternatively, the certain time may be a certain number of a single grant that is not transmitted for the SL-PRS transmission request. In addition or alternatively, the certain time may be configured by another communication node, or may be determined by the transmitting user device 102 itself, or may be pre-defined in the specification.

Additionally, in some implementations including sidelink positioning, one user device 102 may be in different sidelink positioning sessions simultaneously. For example, the user device 102 may act in different UE roles in different sidelink positioning sessions. Each sidelink positioning session may be associated with at least one sidelink positioning quality of service (QoS) requirement. In turn, the user device 102 may to transmit to multiple SL-PRSs to satisfy multiple SL-PRS transmission requests corresponding to multiple QoS of SL positioning services.

Additionally, in some implementations, a dedicated resource pool may only be used to transmit a SL-PRS and a corresponding PSCCH. In event that a user device 102 is scheduled and/or configured to transmit in a dedicated pool, and if only one grant can be used by the user device 102, it may not be possible or inefficient to use only one grant with several re-transmissions and a single periodicity to satisfy multiple SL-PRS transmission requests corresponding to the SL-PRSs pending to be transmitted. On the other hand, in other implementations, it may be more efficient for the user device 102 to use parallel processes to determine a grant and transmit the SL-PRS in a dedicated resource pool. For at least some of these other implementations, each process in the parallel processes is associated with one grant. Such parallel processes may not include the SL processes that processes SL data. In addition or alternatively, such parallel processes may be performed by the MAC layer/entity of the transmitting user device 102.

Additionally, in some implementations, one or more of the following configurations may be implemented. In a first configuration, a user device 102 may determine the maximum parallel processes X that the user device 102 can use to perform an SL-PRS transmission on a dedicated pool. In a second configuration, the user device 102 may determine the maximum parallel processes Y that the user device 102 can use to perform an SL-PRS transmission using Scheme 2 on a dedicated pool. In a third configuration, for Scheme 1 and a dedicated resource pool, the user device 102 may be configured with one or more CG configurations for a SL-PRS transmission. In at least some implementations of the third procedure, the mapping relationship between one or more CG configurations (e.g. provided by a network device 104) and X parallel processes (e.g., that transmitting user device 102's MAC layer/entity maintains) may be configured by the network 104, or may be calculated by the transmitting user device 102 itself. In a fourth configuration, for Scheme 2 and a dedicated resource pool, the user device 102 may select a grant for each process in the Y parallel processes. In a fifth configuration, the user device 102 may determine the maximum parallel processes Y1 that the user device 102 can use to perform SL-PRS transmissions using Scheme 2. At least some implementations of the fifth configuration may be applied for at least one of: a dedicated pool and a shared pool; or only a shared pool. In a sixth configuration, a user device 102 may determine the maximum parallel processes Z that the user device 102 can use to perform an SL-PRS transmission together with sidelink data. In a seventh configuration, a user device 102 may determine the maximum parallel processes Z1 that the user device 102 can use to perform an SL-PRS transmission using Scheme 2 together with sidelink data.

Additionally, in some implementations, a user device 102 may report the UE capability of whether it supports the use of parallel processes in a shared pool or in a dedicated pool. In addition or alternatively, a user device 102 may report the UE capability of whether it supports the use of parallel processes of Scheme 2 in a shared pool or in a dedicated pool. In addition or alternatively, the user device 102 may report a UE capability of whether it supports to transmit SL-PRS simultaneously in a dedicated resource pool and a shared pool. In addition or alternatively, the user device 102 may report a UE capability that whether it supports to transmit SL-PRS simultaneously for scheme 2 in a dedicated resource pool and in a shared pool. UE can report a UE capability of whether it supports the use of parallel processes for Scheme 2 for a dedicated resource pool and a shared pool. In addition or alternatively, the user device 102 may report a UE capability of whether it supports and/or that it supports the X parallel processes, the Y parallel processes, the Y1 parallel processes, the Z parallel processes, and/or the Z1 parallel processes. In addition or alternatively, one or more of the values X, Y, Y1, Z and Z1 may be configured by a communication node other than the transmitting user device 102, or may be pre-defined or fixed in the specification. In addition or alternatively, each of the parallel processes values X, Y, Y1, Z and Z1 may be an integer larger than 0. In addition or alternatively, Z can be up to 16 and Z1 can be up to 4.

Additionally, in some implementations where a user device 102 is configured according to Scheme 2, for both a shared pool and a dedicated pool to transmit a SL-PRS, the user device 102 may perform a transmit (Tx) resource(s) (re)-selection check at one or more times or instances in order to determine whether to ignore or drop an old grant and select a new grant instead. If the user device's MAC layer determines not to transmit a SL-PRS in a dedicated pool, the grant may be ignored, dropped, or cleared by the user device's 102 MAC layer.

For a dedicated pool, the Tx resource selection check may be performed for each selected grant procedure. In some situations, the user device 102 may employ one or more parallel processes for dedicated pool resource selection. For a shared pool, the Tx resource(s) (re)-selection check procedure may be per SL process.

Additionally, in some implementations, for at least one of dedicated pool and shared pool, a parameter may be used to indicate how many times the transmission opportunities are unused after which a selected grant may be dropped by the MAC layer. The transmission opportunities may include at least one of an initial transmission opportunities or re-transmission opportunities. For example, the user device 102 may count the number of unused transmission opportunities to include both unused initial transmission opportunities and unused re-transmission opportunities. In other words, the number of unused transmission opportunities on resources indicated in the selected sidelink grant is incremented by 1 when each single grant in a resource reservation interval is not used. The initial transmission opportunities and re-transmission opportunities may be transmitted with or without periodicity in any of various implementations.

Additionally, in some implementations for a dedicated pool, transmission opportunities being unused includes a SL-PRS is not transmitted on the transmission opportunities. Additionally in some implementations for a shared pool, transmission opportunities being unused includes both SL data and SL-PRS are not transmitted on the transmission opportunities. Because for a shared pool, if data is transmitted in the initial transmission opportunity, the retransmission should be the same data as in the initial transmission opportunity. However, the SL-PRS may be transmitted in either the initial transmission opportunity or re-transmission opportunity. In turn, if the data is not transmitted for several times, and the number of times reaches the indicated parameter value, the SL-PRS may still use the grant to transmit. So, at this time, the grant may not be released.

In addition or alternatively, the parameter may be separately configured by other communication node, such as a gNB 206 (e.g., via RRC signaling), the LMF 202 (e.g., via SLPP or LPP signaling), or another user device 102 (e.g., via SLPP or PC5-RRC signaling). In addition or alternatively, where DL RRC signaling is used, the parameter is an integer, and some implementations, certain M code may be used, and/or be configured in the mode 2/Ccheme 2 configuration per user device 102. In addition or alternatively, the parameter can reuse the sl-ReselectAfter IE in accordance with any of various wireless communication protocols or standards. In additional alternatively, in some implementations in a shared pool, the number of unused transmission opportunities on resources indicated in the selected sidelink grant may be incremented by 1 when each single grant in a resource reservation interval is not used. Each single grant is used for transmit data and SL-PRS. When SL-PRS is included, the user device 102, in some implementations, may not reach the sl-ReselectAfter value since, at least in some situations because the SL-PRS and data are rarely both quiet on several consecutive resource reservation intervals. In turn, a relatively long time may elapse before the user device 102 can switch grants if the number of unused transmission opportunities on resources indicated in the selected sidelink grant is incremented by 1 for situations when none of the single grants are used in a resource reservation interval (or multiple intervals).

Additionally, for some implementations for at least one of a dedicated pool or a shared pool, if there are multiple SL-PRS transmission requests that last for a certain time, the user device 102 may release the old grant and select a new grant instead. The new grant may be selected to have a smaller periodicity to accommodate several SL-PRS transmission requests.

Additionally, in some implementations in a shared pool, if a selected pool is configured with HARQ feedback, the transmitting user device 102 may monitor and/or receive the receiving user device's HARQ feedback after the transmitting user device 102 sends SL data. However, in some situations, the SL-PRS transmitted in this shared pool may not have HARQ feedback. In addition or alternatively, in some situations, there may be no SL data available, which in turn may cause the MAC layer/entity to generate a MAC PDU with empty data. For such situations, the HARQ feedback may not be needed. In order to reduce or save feedback resources, the shared pool with the HARQ feedback may not be used, and the user device 102 may trigger the grant selection procedure in this SL process and change a pool.

Additionally, in some implementations when a user device 102 selects a grant in a shared pool with HARQ feedback and selects retransmission times only when considering SL data, or when the user device 102 is configured with a maximum retransmission time in a configured grant or a dynamic grant, when the user device 102 receives positive HARQ feedback, the user device 102 may stop the remainder of the retransmission of SL data, so that the remainder of the retransmission opportunities may be wasted since the SL-PRS may not be transmitted on these retransmission opportunities. To avoid wasting retransmission opportunities, one or more of the following procedures may be performed.

In a first procedure, if a user device 102 is to select a retransmission number, the user device's 102 MAC layer/entity may select the retransmission number by considering the sidelink data waiting to be transmitted. Moreover, to avoid wasting retransmission opportunities, the user device 102 may still transmit a SL PRS in the retransmission opportunities in this grant associated with the SL process and the shared pool, even when the user device 102 receives a positively acknowledged feedback of the MAC PDU and the user device 102 stops retransmission of the sidelink data. That is to say, regardless of whether the user device 102 has received a positively or negatively acknowledged feedback of the MAC PDU, or has not received feedback at all, the user device 102 may still transmit a SL PRS in the retransmission opportunities in this grant associated with the SL process and shared pool. The user device 102 may also transmit SL-SCH with no data together with the SL-PRS in the remainder of the retransmission opportunities.

In addition or alternatively, when selecting a retransmission number in the selecting grant procedure, the user device's 102 MAC layer/entity may select two retransmission numbers. A first retransmission number may be for SL-data in the logical channel. A second retransmission number may be for the SL-PRS. In addition or alternatively, in any of various embodiments, a set of the maximum retransmission numbers for a SL-PRS may be configured differently or separately by a communication node other than the transmitting user device 102.

Additionally, in some implementations, in a dedicated resource pool, there is no HARQ feedback for SL-PRS reception. In turn, when the transmitting user device 102 selects a SL-PRS resource for non-periodic reservation, the transmitting user device 102 does not need to ensure a minimum time between any two selected SL-PRS resources as the time to receive and process a PSFCH. However, the transmitting user device 102 may need to ensure that the selected SL-PRS resources for non-periodic reservation can be indicated by the prior SCI.

Additionally, in some implementations, in a shared pool or in a dedicated pool, there may be situations where a user device 102 is not able to transmit two consecutive transmissions with no time gap, such as when different transmissions correspond to multiple transmission beams. For at In addition or alternatively, in some implementations, one or more configurations may be implemented with respect to the time gap between two transmissions. In a first configuration, the time gap between two consecutive transmissions may be configured by other communication node, such as a gNB 206 (e.g., via RRC signaling), the LMF 202 (e.g., via SLPP or LPP signaling), or another user device 102 (e.g., via SLPP or PC5-RRC signaling). In a second configuration, the maximum time gap between two consecutive transmissions can be fixed or pre-defined in a wireless communication specification or standard according to which communication nodes in the wireless communication system 100 communicate. In a third configuration, the minimum time gap between two consecutive transmissions can be fixed or/pre-defined in a wireless communication specification or standard according to which communication nodes in the wireless communication system 100 communicate. In a fourth configuration, the user device 102 may report the UE capability of the minimum time gap between two consecutive transmissions. Also, for at least some of these implementations, the two consecutive transmissions may include at least one of the following: two consecutive SL-PRS transmissions, two consecutive of a PSCCH and a SL-PRS transmission, two consecutive of a PSSCH and a SL-PRS transmission, or two consecutive of a PSFCH and a SL-PRS transmission. In addition or alternatively, in any of various embodiments, the SL-PRS may otherwise be any reference signal transmitted in PC5. In addition or alternatively, for the two consecutive transmissions including PSCCH and a SL-PRS transmission, the associated SL-PRS resource may be the SL-PRS resource that the SCI in the PSCCH schedules, or the SL-PRS resource may be any SL-PRS resource that is closest to the SCI in the PSCCH.

Additionally, in some implementations, each SLPP session ID may be associated with a specific sidelink positioning session which has a certain QoS requirement. A SLPP message may indicate or convey a SLPP session ID. In a situation where the SLPP message is transferred between the user device 102 and the LMF 102, similar as a LPP message, the SLPP message may also be embedded in the NAS message. In this way, the LMF 202, an access and mobility management function (AMF), and the target user device 102 may still use a location services (LCS) correlation ID and a routing ID to differentiate different SL positioning sessions. That is to say, an SLPP session ID is transparent to the LMF 202 and an AMF. In turn, there is no need to expose or indicate an SLPP session ID to the LMF 202 when the SLPP message is transferred between the user device 102 and the LMF 202.

Additionally, in some implementations, for a target user device 102 receiving service requests with routing IDs, since different routing ID represents different positioning sessions with different QoS, the target user device 102 may assign a SLPP session ID that has one-to-one mapping with a received routing ID. That is to say, if the target user device 102 receives two routing IDs simultaneously, the assigned SLPP session ID may also include different two IDs, not one. However, a mechanism to restrict which routing ID is associated to which SLPP session ID may not be needed. Rather, for at least some implementations, the target user device 102 may ensure that there are no overlapping session IDs during each sidelink positioning session.

Additionally, in some embodiments, for at least one of a sidelink Mobile Terminated Location Request (SL-MT-LR), a sidelink Mobile Originated Location Request (SL-MO-LR), LMF-based positioning, or UE-based positioning, the LMF 202 may request a gNB 206 to configure at least one of the following information to the user device 102, or the LMF 202 may recommend at least one of the following resource allocation configurations to the gNB 206: a preference of using a shared pool or using a dedicated pool; a dedicated pool configuration including the frequency domain configuration of the dedicated pool and/or a time domain configuration of the dedicated pool; a SL-PRS symbol number; a SL-PRS comb size; a SL-PRS comb offset; a SL-PRS bandwidth; a SL-PRS repetition number; a SL-PRS retransmission number; a SL-PRS periodicity; or a SL-PRS priority. Also, for at least some implementations, a gNB 206 may determine one or more final resource allocation configurations, and provide it to the LMF 206. In other implementations, the above-described actions may be conveyed in a NR positioning protocol A (NRPPa) message or a next generation application protocol (NGAP) message.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:
A first aspect includes a method for wireless communication that includes: determining, by a user device, a grant of one or more grants for a reference signal (RS) resource allocation; determining, by the user device, one or more RS characteristics in each RS transmission opportunity of one or more RS transmission opportunities in the grant; and transmitting, by the user device, a RS on each RS transmission duration corresponding to a respective one of the one or more transmission opportunities.
A second aspect includes the first aspect, and further includes wherein the one or more RS characteristics comprises at least one of: a session of a RS transmission, a priority of the RS transmission, a cast type of the RS transmission, a destination information of the RS transmission, a source information of the RS transmission, a delay budget of the RS transmission, or a sequence identification (ID) of the RS transmission.
A third aspect includes any of the first or second aspects, and further includes determining, by the user device, a maximum number of parallel processes that the user device can determine for more than one grant to transmit the RS in a dedicated pool.
A fourth aspect includes any of the first through third aspects, and further includes wherein the user device determines the maximum number of parallel processes based on a resource selection to determine the RS resource allocation.
A fifth aspect includes any of the third or fourth aspects, and further includes reporting, by the user device, at least one of: a capability of whether the user device supports use of parallel processes for a dedicated pool, or a maximum number of the parallel processes for a dedicated pool that the user device supports.
A sixth aspect includes any of the first through fifth aspects, and further includes transmitting, by the user device, more than one RS resources in a slot for a dedicated pool.
A seventh aspect includes any of the first through sixth aspects, and further includes wherein the one or more RS transmission opportunities comprises an initial RS transmission opportunity and a RS retransmission opportunity, the method further comprising: reselecting, by the user device, the grant when a number of unused transmission opportunities in the grant in a dedicated pool reaches a configured parameter, wherein an unused transmission opportunity comprises either an initial RS transmission opportunity or a RS retransmission opportunity where a corresponding resource is not used for the RS.
An eighth aspect includes any of the first through seventh aspects, and further includes wherein the one or more RS transmission opportunities comprises an initial RS transmission opportunity and a RS retransmission opportunity, the method further comprising: reselecting, by the user device, the grant when a number of unused transmission opportunities in the grant in a shared pool reaches a configured parameter, wherein an unused transmission opportunity comprises either an initial RS transmission opportunity or a RS retransmission opportunity where a corresponding resource is not used for the RS and sidelink data.
A ninth aspect includes any of the first through eighth aspects, and further includes wherein the user device determines the one or more RS characteristics in each RS transmission opportunity to be the same as one or more RS characteristic for a RS transmission having a highest priority among all RS transmissions pending to be transmitted.
A tenth aspect includes any of the first through ninth aspects, and further includes wherein the user device determines the one or more RS characteristics in each RS transmission opportunity to be the same as one or more RS characteristics for a RS transmission having a highest priority among all RS transmissions pending to be transmitted and are allowed to be chosen for transmission.
An eleventh aspect includes any of the first through tenth aspects, and further includes wherein the user device determines the one or more RS characteristics for a RS in each RS transmission opportunity to be the same as one or more RS characteristics for a RS transmission having a minimum remaining delay budget (DB) among all RS transmissions pending to be transmitted.
A twelfth aspect includes any of the first through eleventh aspects, and further includes wherein the one or more RS transmission opportunities comprises a RS retransmission opportunity, and wherein the user device determines one or more RS characteristics for a RS in the RS retransmission opportunity to be the same as one or more RS characteristics for a RS in a corresponding initial RS transmission opportunity.
A thirteenth aspect includes any of the first through twelfth aspects, and further includes wherein the one or more RS characteristics comprises a characteristic of whether or not a medium access control (MAC) protocol data unit (PDU) that is transmitted with the RS in a same slot comprises only padding bits.
A fourteenth aspect includes the thirteenth aspect, and further includes wherein the characteristic is indicated in a sidelink shared channel (SL-SCH) subheader of the MAC PDU.
A fifteenth aspect includes any of the thirteenth or fourteenth aspects, and further includes wherein the characteristic is indicated in a sidelink control information (SCI) comprising a SCI format 2-D using a source identification (ID) with 0 bits or 24 bits and a destination identification (ID) with 0 bits or 24 bits.
A sixteenth aspect includes any of the first through fifteenth aspects, and further includes wherein the user device determines the characteristic according to a first number of consecutive transmissions and a second number of stop transmissions.
A seventeenth aspect includes the sixteenth aspect, and further includes wherein at least one of: when a first RS with a priority is transmitted consecutively to a destination for the first number, transmission of a second RS with the priority to the destination is not allowed to be chosen for transmission for the second number; when a first RS with a priority and associated with a session is transmitted consecutively for the first number, transmission of a second RS with the priority and associated with the session is not allowed to be chosen for transmission for the second number; the consecutive transmissions for the first number and the stop transmissions for the second number each comprise at least one of the following: initial transmissions, initial transmissions and retransmissions, initial transmissions to the destination, initial transmissions and retransmissions to the destination, initial transmissions of the session, or initial transmissions and retransmissions of the session.
An eighteenth aspect includes any of the fifteenth through seventeenth aspects, and further includes wherein the user device determines the one or more RS characteristics according to a first time period of consecutive transmissions and a second time period of stop transmissions.
A nineteenth aspect includes the eighteenth aspect, and further includes wherein at least one of: when a first RS with a priority is transmitted consecutively to a destination for the first time period, transmission of a second RS with the priority to the destination is not allowed to be chosen for transmission for the second time period; or when a first RS with a priority and with a session is transmitted consecutively for the first time period, transmission of a second RS with the priority and with the session is not allowed to be chosen for transmission for the second time period.
A twentieth aspect includes any of the first through nineteenth aspects, and further includes wherein the user device determines the RS characteristic according to a user device variable among one or more user device variables, and wherein the user device determines the one or more RS characteristics in each RS transmission opportunity to be the same as one or more RS characteristic for a RS transmission having a lowest user device variable value among all RS transmissions pending to be transmitted and that are allowed to be chosen for transmission.
A twenty-first aspect includes the twentieth aspect, and further includes wherein each user device variable of the one or more user device variables is associated with at least one of the destination of the RS transmission, or the session of the RS transmission.
A twenty-second aspect includes the twenty-first aspect, and further includes wherein at least one of: an initial value of the user device variable is set to a priority value of a current RS transmission; the user device variable value is increased by one when a corresponding RS is successfully transmitted in a RS transmission opportunity; the user device variable value is decreased by one when the corresponding RS is pending to be transmitted and is not transmitted in a second RS transmission opportunity; the user device variable is decreased by one when the corresponding RS with the second characteristic is pending to be transmitted and is not transmitted during a predetermined time period.
A twenty-third aspect includes any of the first through twenty-second aspects, and further includes wherein the one or more RS characteristics comprises a time gap between two consecutive transmissions, and wherein the two consecutive transmissions comprises at least one of: two RSs, a physical sidelink control channel (PSCCH) and the RS, or a physical sidelink shared channel (PSSCH) and the RS.
A twenty-fourth aspect includes the twenty-third aspect, and further includes wherein at least one of: the time gap or a maximum time gap between the two consecutive transmissions is configured by a communication node other than the user device, wherein the communication node comprises a gNB that configures the time gap via radio resource control (RRC) signaling, a location management function (LMF) that configures the time period via sidelink positioning protocol (SLPP) signaling or LTE positioning protocol (LPP) signaling, or a second user device that configures the time period via SLPP signaling or PC5-RRC signaling; or the user device reports a minimum time gap between the two consecutive transmissions that the user device is capable of using.
A twenty-fifth aspect includes a wireless communications apparatus comprising a processor and a memory, wherein the processor is configured to read code from the memory to implement any of the first through twenty-fourth aspects.
A twenty-sixth aspect includes a computer program product comprising a computer-readable program medium comprising code stored thereupon, the code, when executed by a processor, causing the processor to implement any of the first through twenty-fourth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, by a user device, a grant for a reference signal (RS) resource allocation;
determining, by the user device, one or more RS characteristics in each RS transmission opportunity of one or more RS transmission opportunities in the grant; and
transmitting, by the user device, a RS on the each RS transmission opportunity based on the one or more RS characteristics.

2. The method of claim 1, wherein the one or more RS characteristics comprises at least one of: a priority of the RS transmission, a cast type of the RS transmission, a destination information of the RS transmission, a source information of the RS transmission, or a delay budget of the RS transmission.

3. The method of claim 1, wherein the user device determines the one or more RS characteristics in each RS transmission opportunity to be the same as one or more RS characteristic for a RS transmission having a highest priority among all RS transmissions pending to be transmitted.

4. The method of claim 1, wherein the one or more RS transmission opportunities comprises a RS retransmission opportunity, and wherein the user device determines one or more RS characteristics for a RS in the RS retransmission opportunity to be the same as one or more RS characteristics for a RS in a corresponding initial RS transmission opportunity.

5. The method of claim 1, wherein the one or more RS characteristics comprises a characteristic of whether or not a medium access control (MAC) protocol data unit (PDU) that is transmitted with the RS in a same slot comprises only padding bits.

6. The method of claim 5, wherein the characteristic is indicated in a sidelink shared channel (SL-SCH) subheader of the MAC PDU.

7. The method of claim 1, wherein the user device determines the characteristic according to a first number of consecutive transmissions and a second number of stop transmissions.

8. The method of claim 7, wherein at least one of:
when a first RS with a priority is transmitted consecutively to a destination for the first number, transmission of a second RS with the priority to the destination is not allowed to be chosen for transmission for the second number;
when a first RS with a priority and associated with a session is transmitted consecutively for the first number, transmission of a second RS with the priority and associated with the session is not allowed to be chosen for transmission for the second number; or
the consecutive transmissions for the first number and the stop transmissions for the second number each comprise at least one of the following: initial transmissions, initial transmissions and retransmissions, initial transmissions to the destination, initial transmissions and retransmissions to the destination, initial transmissions of the session, or initial transmissions and retransmissions of the session.

9. The method of claim 1, wherein the user device determines the one or more RS characteristics according to a first time period of consecutive transmissions and a second time period of stop transmissions.

10. The method of claim 9, wherein at least one of:
when a first RS with a priority is transmitted consecutively to a destination for the first time period, transmission of a second RS with the priority to the destination is not allowed to be chosen for transmission for the second time period; or
when a first RS with a priority and with a session is transmitted consecutively for the first time period, transmission of a second RS with the priority and with the session is not allowed to be chosen for transmission for the second time period.

11. The method of claim 1, wherein the one or more RS characteristics comprises a time gap between two consecutive transmissions, and wherein the two consecutive transmissions comprises a physical sidelink feedback channel (PSFCH) and the RS.

12. The method of claim 11, wherein
the user device reports a minimum time gap between the two consecutive transmissions that the user device is capable of using.

13. A wireless communications apparatus comprising:
a memory storing a plurality of instructions; and
at least one processor configured to execute the plurality of instructions, wherein upon execution of the plurality of instructions, the at least one processor is configured to:
determine a grant for a reference signal (RS) resource allocation;
determine one or more RS characteristics in each RS transmission opportunity of one or more RS transmission opportunities in the grant; and
transmit a RS on the each RS transmission opportunity based on the one or more RS characteristics.

14. The wireless communications apparatus of claim 13, wherein the one or more RS characteristics comprises at least one of: a priority of the RS transmission, a cast type of the RS transmission, a destination information of the RS transmission, a source information of the RS transmission, or a delay budget of the RS transmission.

15. The wireless communications apparatus of claim 13, wherein the at least one processor, upon execution of the plurality of instructions, is configured to determine the one or more RS characteristics in each RS transmission opportunity to be the same as one or more RS characteristic for a RS transmission having a highest priority among all RS transmissions pending to be transmitted.

16. The wireless communications apparatus of claim 13, wherein the one or more RS characteristics comprises a time gap between two consecutive transmissions, and wherein the two consecutive transmissions comprises a physical sidelink feedback channel (PSFCH) and the RS.

17. The wireless communications apparatus of claim 16, wherein the at least one processor, upon execution of the plurality of instructions, is configured to report a minimum time gap between the two consecutive transmissions that the wireless communications apparatus is capable of using.

18. A non-transitory computer-readable storage medium storing a plurality of instructions executable by a at least one processor, wherein when executed by the at least one processor, the plurality of instructions are configured to cause the at least one processor to:
determine a grant for a reference signal (RS) resource allocation;
determine one or more RS characteristics in each RS transmission opportunity of one or more RS transmission opportunities in the grant; and
transmit a RS on the each RS transmission opportunity based on the one or more RS characteristics.

19. The non-transitory computer-readable storage medium of claim 18, wherein the one or more RS characteristics comprises at least one of: a priority of the RS transmission, a cast type of the RS transmission, a destination information of the RS transmission, a source information of the RS transmission, or a delay budget of the RS transmission.

20. The non-transitory computer-readable storage medium of claim 18, wherein when executed by the at least one processor, the plurality of instructions are configured to cause the at least one processor to determine the one or more RS characteristics in each RS transmission opportunity to be the same as one or more RS characteristic for a RS transmission having a highest priority among all RS transmissions pending to be transmitted.
